(19) United States
(12) Patent Application Publication
(10) Pub. No.: US 2013/0297752 A1
(43) Pub. Date: Nov. 7, 2013

(54) PROVISIONING NETWORK SEGMENTS BASED ON TENANT IDENTITY

(71) Applicants: Shiva Bhanujan, San Jose, CA (US); Ethan M. Spiegel, Mountain View, CA (US); Xin Liu, San Jose, CA (US)

(72) Inventors: Shiva Bhanujan, San Jose, CA (US); Ethan M. Spiegel, Mountain View, CA (US); Xin Liu, San Jose, CA (US)

(73) Assignee: Cisco Technology, Inc., San Jose, CA (US)

(21) Appl. No.: 13/462,554

(22) Filed: May 2, 2012

(51) Int. Cl. G06F 15/177

(52) U.S. Cl. 709/220

(57) ABSTRACT

In one embodiment, a request is generated for a particular device of a computer network for a unique segment identifier (ID) for a network segment comprising one or more devices sharing a unique tenant ID. The request has a request-context that includes the tenant ID and a protocol of the network segment. The request is transmitted a segment ID manager and, as a result, the segment ID manager generates and transmits a response that indicates the unique segment ID for the network segment based on the request-context. Subsequently, the particular device may then be configured to communicate on the network segment with the one or more devices based on the unique segment ID of the response.

### TECHNICAL FIELD

The present disclosure relates generally to computer networks, and, more particularly, to communication isolation for devices on particular network segments.

### BACKGROUND

The Open Systems Interconnection (OSI) model is a reference model that provides conceptual framework of standards for communication across different devices, equipment, and applications in a network. In particular, the OSI model defines seven layers for communications processes, which divides the tasks involved with moving information between networked computers into seven smaller, more manageable task groups.

Private network segments can be established for one or more of the seven layers of the OSI model to isolate communication amongst a particular set of devices (e.g., devices for tenants such as customers, enterprises, businesses, etc.). However, establishing and ensuring efficient tenant isolation (cloud customer isolation) is a complex problem. Various attempts to date provide top-down approaches and/or isolation based on manual mapping. Top-down approaches such as a Dynamic Host Configuration Protocol (DHCP) attempts to configure tenant devices using traditional database mapping techniques that establish the network segment according to complex and exacting pre-configuration parameters. Once the network segment is established, devices can be configured to communicate on the network segment by providing a request that identifies those same configuration parameters. However, this cumbersome approach proves complex, and fails to efficiently establish and ensure device isolation on particular network segments.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network;

FIG. 2 illustrates an example network device/node;

FIG. 3 illustrates an example view of the communication network organized according to unique segment identifiers;

FIG. 4 illustrates an example of a request for a unique segment ID and a corresponding response for the unique segment ID;

FIG. 5 illustrates an example view of a network having multiple segment ID managers;

FIG. 6 illustrates an example simplified procedure for provisioning segment identifiers based on tenant IDs, particularly from the perspective of the configured device; and

FIG. 7 illustrates an example simplified procedure for provisioning segment identifiers based on tenant IDs, particularly from the perspective of a segment ID manager.

### DESCRIPTION OF EXAMPLE EMBODIMENTS

### Overview

According to one or more embodiments of the disclosure, a particular device of a computer network generates and a request for a unique segment identifier (ID) for a network segment comprising one or more devices sharing a unique tenant ID. The request has a request-context that includes the unique tenant ID and a protocol of the network segment. The particular device transmits the request to a segment ID manager, and subsequently, receives a response from the segment ID manager. The response indicates the unique segment ID for the network segment based on the request-context. The particular device may then be configured to communicate on the network segment with the one or more devices based on the unique segment ID of the response.

According to one or more additional embodiments, a segment identifier (ID) manager receives the request from a device, e.g., a tenant device, and determines if the unique segment ID was previously generated for the unique tenant ID and the protocol of the network segment and, either instantiates the unique segment ID for the unique tenant ID (and protocol of the network segment), or, alternatively, identifies the previously generated unique segment ID for the unique tenant ID. In either case, the segment ID manager further generates a response for the request, which indicates the unique segment ID for the network segment based on the request-context, and transmits the response to the device.

### DESCRIPTION

A computer network comprises geographically distributed nodes (e.g., devices of a distributed data center or end-client devices such as personal computers and workstations, or other devices) interconnected by communication links and segments for transporting data between end nodes. Various types of network are available and can include, for example, local area networks (LANs), wide area networks (WANs), etc. Each of these networks can connect the nodes over dedicated private communication links, or dispersed nodes over long-distance communications links such as common carrier telephone lines, optical lightpaths, synchronous optical networks (SONET), synchronous digital hierarchy (SDH) links, or Powerline Communications (PLC), and others.

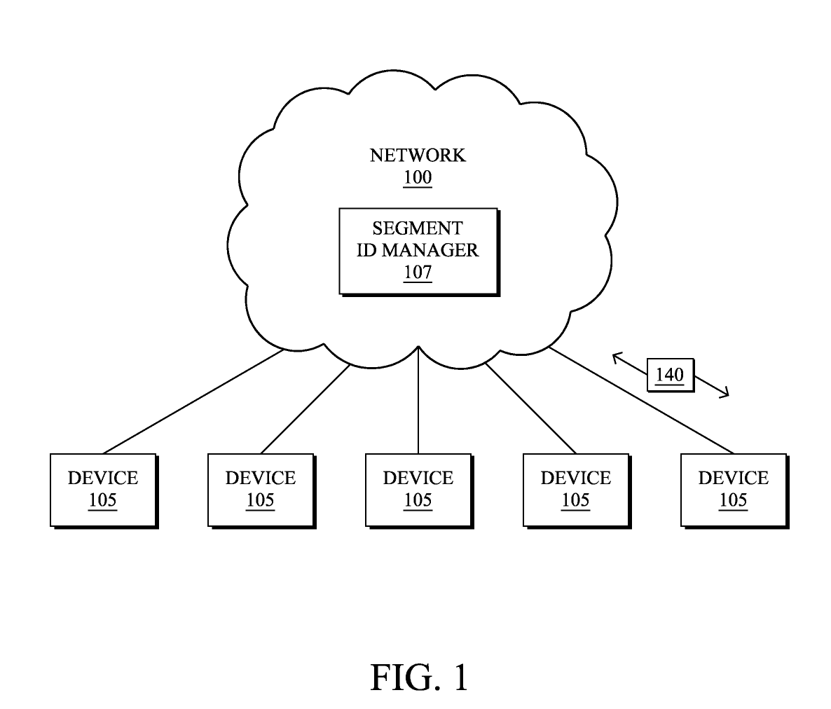

FIG. 1 is a schematic block diagram of a simplified example computer network 100 illustratively comprising nodes/devices 105 interconnected by various methods of communication and, as described below, across various network segments. For example, each of the devices can communicate with other devices using predefined network communication protocols as will be appreciated by those skilled in the art, such as various wired protocols, wireless protocols (e.g., IEEE Std. 802.15.4, WiFi, Bluetooth®, etc.), PLC protocols, other shared-media protocols, etc. Devices 105 may comprise hardware such as servers, communication hardware (e.g., routers, switches, etc.), computers, and client devices. Data packets 140 may be exchanged among the nodes/devices of the computer network 100 using predefined network communication protocols such as certain known wired protocols, wireless protocols or other shared-media protocols, etc. where appropriate. In this context, a protocol consists of a set of rules defining how the nodes interact with each other. In addition, one or more segment ID managers 107 may also be present within the network (e.g., within a control/management center), for use as described below. Those skilled in the art will understand that any number of nodes, devices, links, etc. may be used in the computer network, and that the view shown herein is for simplicity.

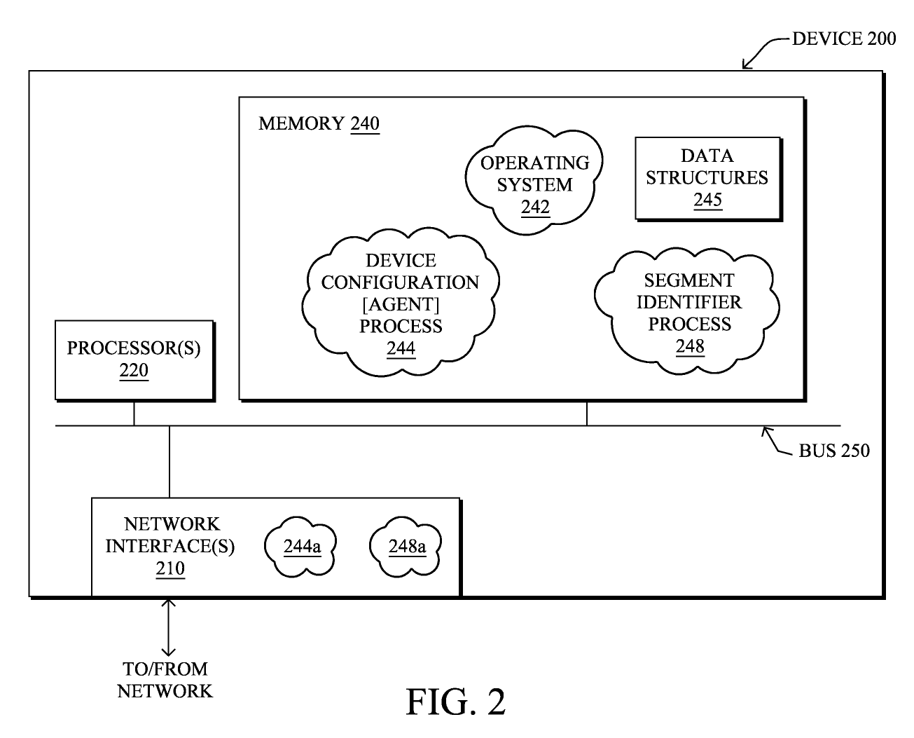

FIG. 2 is a schematic block diagram of a simplified example device 200 that may be used with one or more embodiments described herein, e.g., as any of the devices 105 and/or the segment ID manager 107 shown in FIG. 1 above. Device 200 may comprise one or more network interfaces 210 (e.g., wired, wireless, etc.), at least one processor 220, and a memory 240 interconnected by a system bus 250.

The network interface(s) 210 contain the mechanical, electrical, and signaling circuitry for communicating data over network 100. Network interfaces 210 may be configured to transmit and/or receive data using a variety of different communication protocols. Note that each device may include two different types of network connections 210, e.g., wireless and wired/physical connections, and that the view herein is merely for illustration.

Memory 240 comprises a plurality of storage locations that are addressable by the processor 220 and the network interfaces 210 for storing software programs and data structures associated with the embodiments described herein. Processor 220 may comprise hardware elements or hardware logic adapted to execute the software programs and manipulate the data structures 245. An operating system 242, portions of which are typically resident in memory 240 and executed by the processor, functionally organizes the device by, inter alia, invoking operations in support of software processes and/or services executing on the device. These software processes and/or services may comprise device configuration (agent) process/services 244 (e.g., for devices 105), and a segment identifier process 248 (e.g., for segment ID manager 107), as described herein. Note that while processes 244 and 248 are shown in centralized memory 240, alternative embodiments provide for either of the processes to be specifically operated within the network interfaces 210, such as a component of a MAC layer (e.g., process “244a/248a”).

Note further that while both processes 244 and 248 are shown as installed in a memory 240, and therefore being implemented in software, these processes could be implemented in any of hardware (e.g., electronic circuitry), firmware, software, or a combination thereof. Alternatively, these processes may be configured on a storage medium for subsequent loading into memory 215. The storage medium can include a computer-readable medium encoded with a computer program, and can be any conventional storage medium that stores the processes thereon in tangible form. Examples of storage media include a floppy disk, a compact disk, a magnetic tape, a read only memory, an optical storage media, universal serial bus (USB) flash drive, etc. Alternatively, storage media can include a random access memory, or other type of electronic storage, located on a remote storage system and coupled to processor 220, via network interface 210.

As will be apparent to those skilled in the art other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

As noted above, it is desirable for cloud customers or “tenants” (e.g., consumers or subscribers of a network service provided by a virtual data center, such as customers, enterprises, businesses, etc.) to efficiently establish private (secure and exclusive) network segments to ensure isolated communication amongst a particular set of tenant devices. For instance, each device participating in a virtual data center for a particular tenant needs to be configured in a coordinated manner to ensure that the tenant traffic is completely isolated. As an example, all virtual machines provisioned for a particular tenant may be configured to reside in their own private virtual LAN (VLAN) segment, providing total isolation from other environments. A network segment, then, is a logical network structure that connects devices (e.g., virtual machines) together. When virtual machines are provisioned to reside in respective private VLAN segments, network traffic is only allowed to reach a tenant device over an explicitly defined network segment. In this manner, network segments may provide the basis for applying different quality of service (QoS) parameters, guaranteeing service-level agreements (SLAs), and provide essential tenant specific debugging functionality. Despite efforts to date, however, establishing and ensuring efficient tenant isolation has proven to be a particularly complex problem.

For instance, in addition to DHCP discussed above, other traditional tenant isolation techniques include employing an identity agent that stores identity information for a user. However, according to these techniques the identity agent only provides an automatic form filling functionality, e.g., mapping parameters, for devices requesting to communicate on a network segment. Further, these mapping parameters require initial manual entry of a user generated mapping system. These maps link stored information to requested information and are established by users, which can be shared as a community endeavor to provide a distributed mapping effort. However, these policies require cooperation and coordination amongst the community and can be susceptible to erroneous map data from user-entry.

The techniques herein provide for efficient tenant isolation for tenant devices on corresponding network segments. In particular, as described herein, the techniques provide for identity management for network devices for isolating communication on private network segments based on a tenant identity. For example, as one specific embodiment, the techniques herein may be used for provisioning devices within virtual data centers.

Illustratively, the techniques described herein may be performed by hardware, software, and/or firmware, such as in accordance with the device configuration (agent) process 244/244a (e.g., when executed on a device 105 or agent of the device as described below), and the segment identifier process 248/248a (e.g., when executed on a segment ID manager 107), which may each contain computer executable instructions executed by processor 220 to perform functions relating to the techniques described herein.

Operationally, under the control of device configuration (agent) process 244 a tenant device 105 of a computer network 100, or else a device agent acting on behalf of a tenant device, generates a request for a unique segment identifier (ID) for a network segment (comprising one or more devices sharing a unique tenant ID), and transmits it to a segment ID manager 107. The request has a request-context that includes a unique tenant ID of the device (e.g., provisioned/assigned by a service provider of the computer network for the particular tenant) and a protocol of the network segment. The device (or the device agent) may then receive a response indicating the unique segment ID, such that the device may be configured to communicate on the network segment with the one or more devices based on the unique segment ID, accordingly.

Moreover, under the control of segment identifier process 248, a segment ID manager 107 receives the request from the tenant device and, after receiving the request, may determine if the unique segment ID was previously generated for the unique tenant ID and the protocol of the network segment, and either instantiates the unique segment ID for the unique tenant ID (and protocol of the network segment), or, alternatively, identifies the previously generated unique segment ID for the unique tenant ID. In either case, the segment ID manager further generates a response for the request, which indicates the unique segment ID for the network segment based on the request-context, and transmits the response to the device.

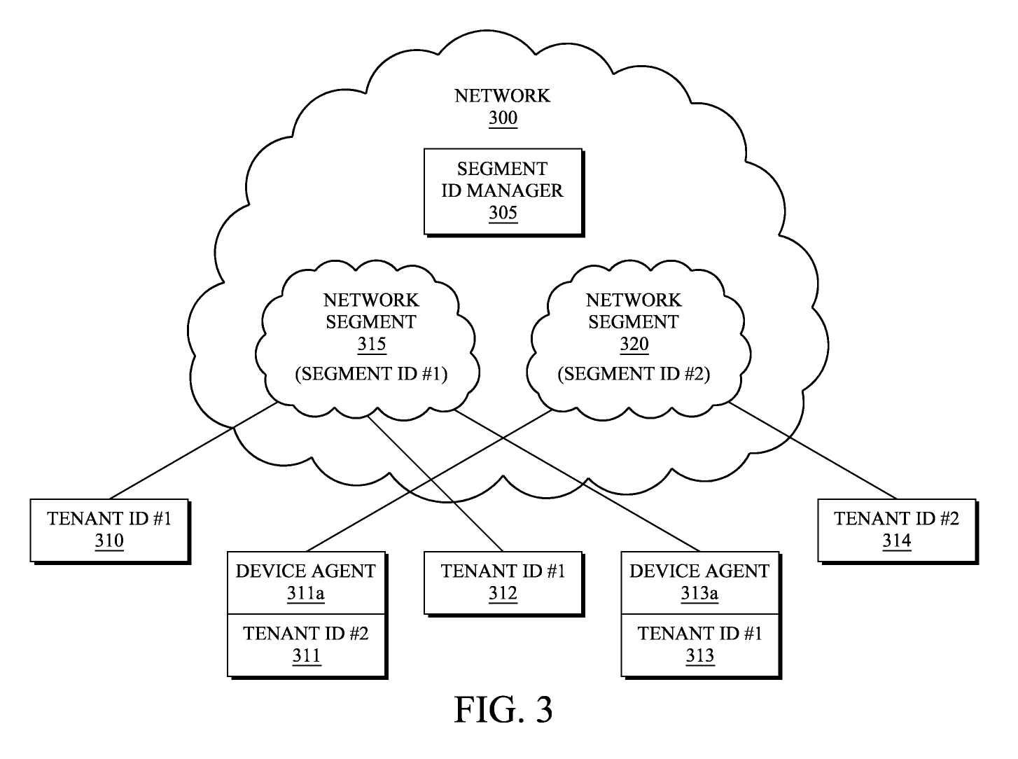

For example, FIG. 3 provides an example view of a segment ID manager 305 (107 in FIG. 1) and devices 310-314 (105 in FIG. 1), according to one embodiment of the present disclosure. Note that one or more of the devices may be associated with device agents acting on behalf of the devices themselves, for example, devices 311 (agent 311a) and device 313 (agent 313a), such as where the devices are not configured to participate in the techniques herein, and where the agents may thus configure their respective devices, accordingly. Note further that while a 1-to-1 mapping of device agent to device is shown, a single device agent may be responsible for configuring a plurality of devices, and the view shown herein is merely a simplified example.

In particular, as shown in FIG. 3, the devices may be configured to communicate on isolated network segments (e.g., network segment “#1” 315 or “#2” 320), based on the unique segment ID(s) provided by the segment ID manager 305. For instance, devices 310-314 may all communicate with the shared network 300. Each of the devices 310-314, however, may illustratively desire to communicate with certain other devices on an isolated network segment—namely network segment 315 or 320.

As an illustrative example, network 300, including network segments and devices in communication therewith, can be provisioned for a virtual data center according to a tenant request. Virtual data centers (vDCs) are composed of nodes that perform certain functionalities (e.g., virtual machines or “VMs”) and network segments that connect these nodes (e.g., VMs talking on a VLAN). When a tenant requests for a vDC, it informs the segment ID manager of the tenant ID, along with the desired network protocol, to request that a name be assigned to the vDC (network 300, generally). Example protocols may comprise a virtual routing and forwarding (VRF) protocol, a VLAN tagging protocol such as IEEE Std. 802.1Q (“dot1Q”), a stacked VLAN protocol such as in IEEE Std. 802.1ad (often referred to as “Q-in-Q” or “QinQ”), a border gateway protocol (BGP), an interior gateway protocol (IGP), a multi-protocol label switching (MPLS) protocol or other tunneling protocols, a wireless transmission protocol, etc.

A middleware provisioning layer (not shown) may determine where to place the request, and provisions a set of tenant devices to fulfill the request, e.g., one or more of tenant devices 310-314, and establishes a framework for network segments within the network 300. In other words, the nodes/devices may be mapped to certain edge devices, and the network segments may be mapped into paths in the vDC network, where the paths interconnect the tenant devices of a particular network segment. Multiple devices participate in a network, and, as they are connected via multiple segments, all of these segments essentially comprise network 300 (e.g., where multiple networks may be used/interconnected to create a virtual data center).

That is, once a network segment framework is established, paths can be “stitched” or established for each device to communicate with each other on a particular network segment based on the segment IDs, which are allocated and mapped based on a tenant ID and protocol ID (e.g., and a “sub-tenant” ID, described below) of a corresponding device. Specifically, similar contexts are used by other devices desiring to be within the same network segment, resulting in complementary segments IDs, which are downloaded to those devices in order to stitch the network segment together (e.g., in the virtual data center). Put differently, a request-context sent by each of two devices/agents is identical where a network segment needs to be stitched between the two network devices. Accordingly, the segment ID manager (e.g., for a virtual data center) assigns same identifiers for the two devices that are on the same segment. In the case of different tenants, the segment ID (e.g., name of the network) would be different, as these are supposed to be unique. As a result, the request-context generated for an network ID request in a virtual data center would be unique, and hence, the identifiers generated for different tenants would not overlap.

As illustrated in FIG. 3, segment ID manager 305 stitches the paths for each device to communicate on an isolated network segment according to requests for devices based on a request-context, as described above. For instance, the segment ID manager 305 identifies (or instantiates) a unique segment ID for a network segment corresponding to the unique tenant ID and the network protocol of the request for two illustrative network segments “#1” 315 and “#2” 320. The segment ID manager 305 further sends a response to devices indicating the unique segment ID for a corresponding network segment. The devices, in turn, are configured (e.g., via a device agent) to communicate on the corresponding (isolated) network segment based on the unique segment ID. For example, devices 310, 312 and 313 are configured to communicate on network segment #1 (315), while devices 311 and 314 are configured to communicate on network segment #2 (320). In this fashion, network segments are assigned unique segment IDs, which correspond to unique tenant IDs provided in requests for devices. Note that the unique segment ID for a given network segment can be provided to each device individually, or else in tandem to multiple devices, to establish the corresponding network segment, accordingly.

It is important to note again that various configurations are contemplated by this disclosure. For example, the processes discussed herein can be executed and coordinated on behalf of devices by a device agent, or, alternatively by the device itself. For example, as illustrated, the device agent can generate and transmit the request on behalf of the device and, further, the device agent can configure the device to communicate on the network segment.

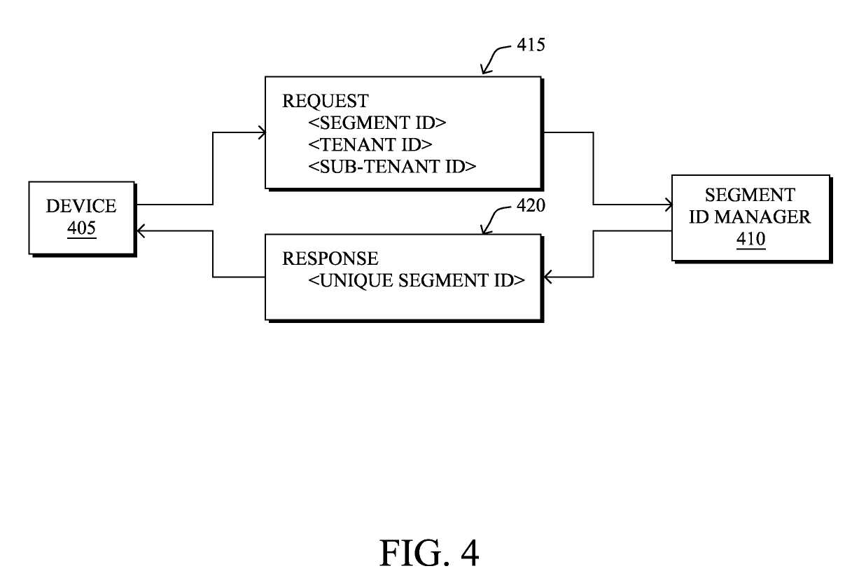

FIG. 4 illustrates a simplified example of an exchange of request and a corresponding response. In particular, FIG. 4 illustrates a flow of request(s) 415 from a device 405 to a segment ID manager 410 and response(s) 420 from the segment ID manager 410 to the device 405. In this embodiment, device 405 is illustrated without any corresponding device agent(s), and generates requests and receives responses as a standalone device. As noted above, however, the communication with the segment ID manager may be performed by a device agent acting on behalf of the underlying device.

As shown, the device 405 generates a request 415 for a unique segment identifier (ID) for a network segment (e.g., network segment 315 or network segment 320). The request has a request-context that includes a unique tenant ID of the device and a protocol of the network segment. For example, a request-context can include a unique tenant ID (an organizational context), generally assigned to the tenant according to a contractual relationship with the network service provider (e.g., a name, a domain, an ID number, etc.), as well as specifics of network protocol for one or more network segments. Note that a device may be configured to communicate (in an isolated manner) on more than one network segment (e.g., dot1Q and IPv4). As an illustrative example, a request by a device (e.g., an aggregation device for a data center edge-facing aggregation network segment) may specify two different protocols for two respective segments, e.g., a dot1Q segment and an IPv4 segment, as follows:

<!-- DataCenterEdge facing Aggregation -->
<id technology=“dot1q”>
<pool-context>
<scope>local</scope>
<endpoint>gige1-1</endpoint>
</pool-context>
<identifier-context>
<network-segment name=“DataCenterEdge-Aggregation”/>
</identifier-context>
</id>
<id technology=“ipv4”>
<pool-context/>
<subpool-context>
<scope>local</scope>
<subnet name=“DataCenterEdge-Aggregation”/>
<endpoint>gige1-1</endpoint>
</subpool-context>
<identifier-context>
<requester-jid/>
</identifier-context>
<reference-info>
<role>NetworkNode</role>
<subrole>DataCenterEdge</subrole>
</reference-info>
</id>

Device 405 transmits the request to a segment ID manager 410, which receives the request 415 and determines if the unique segment ID was previously generated for the unique tenant ID and the protocol of the network segment. The segment ID manager may then either instantiate the unique segment ID for the unique tenant ID (and protocol of the network segment), or, alternatively, identifies the previously generated unique segment ID for the unique tenant ID. In either case, the segment ID manager generates response 420, which indicates the unique segment ID for the network segment based on the request-context, and transmits response 420 to be received by the device 405. Note that the response 420 may generally be in the same format as the request 415, but now includes the segment ID(s).

Upon receipt, the device is configured (e.g., by a device agent) to communicate on the network segment based on the unique segment ID of the response. By assigning the same identifier, e.g., the unique segment ID, to different devices requesting the same context, multiple devices may be correspondingly configured to communicate on the same network segment.

As an illustrative example, assume that an enterprise tenant “Company A” (e.g., WALMART®) contracts with a network/cloud service provider to provision a private network segment. As devices of Company A (e.g., tenant devices) are configured to communicate with one another, whether physical machines (e.g., PCs) or virtual machines or both, the tenant devices request the unique segment ID from the service provider's segment ID manager. Each device of Company A submits the same tenant ID and, in response, the devices receive the same unique segment ID. Accordingly, the devices can establish communication channels amongst themselves. Conversely, should a different tenant “Company B” (e.g., TARGET®) wish to establish a private network segment, then the request-context for Company B's devices would include a different (unique) tenant ID than Company A, and thus the resultant segment ID for Company B, which is based on the unique tenant ID, would also be different (unique). This ensures that devices of Company A and devices of Company B are not configured with overlapping segment IDs, and communicate on isolated and private network segments.

As noted above, in some embodiments, the request-context can further include a sub-tenant ID of the device, e.g., to represent multiple tiers where segment ID would thus be able to distinguish between the multiple tiers (notably, the “sub-pool context” in the example IPv4 request above). For example, for a larger tenant having multiple departments (e.g., a Company A, having a human resources (HR) department), the request-context can include both the unique tenant ID (e.g., Company A) and the sub-tenant ID (HR department). As an alternative example, a departmental application that processes financial data within the private cloud of an enterprise may be considered a sub-tenant of that enterprise (e.g., WALMART® Financial versus WALMART® Marketing departments). In these embodiments, the unique segment ID for the network segment is based on the unique tenant ID, the sub-tenant ID, and the protocol of the network segment. Thus, communication for devices can be partitioned and isolated for a company based on a sub-tenant ID. Any type of sub-tenant ID or tier may be defined, such as based on company departments, device access/security levels, device types, device responsibilities, device capabilities, geographic locations, etc.

Furthermore, in certain embodiments, the unique segment IDs can be ported across data centers (which house the devices that communicate on the various networks) such that a same network is shared. This shared network can further maintain network resources (e.g., devices configured to communicate on particular network segments) in the event that one or more data centers are inadvertently shut down (e.g., power failure). That is, globally assigning unique segment IDs for network segments across various data centers can efficiently provide for dynamic provisioning and maintenance of network resources (e.g., devices).

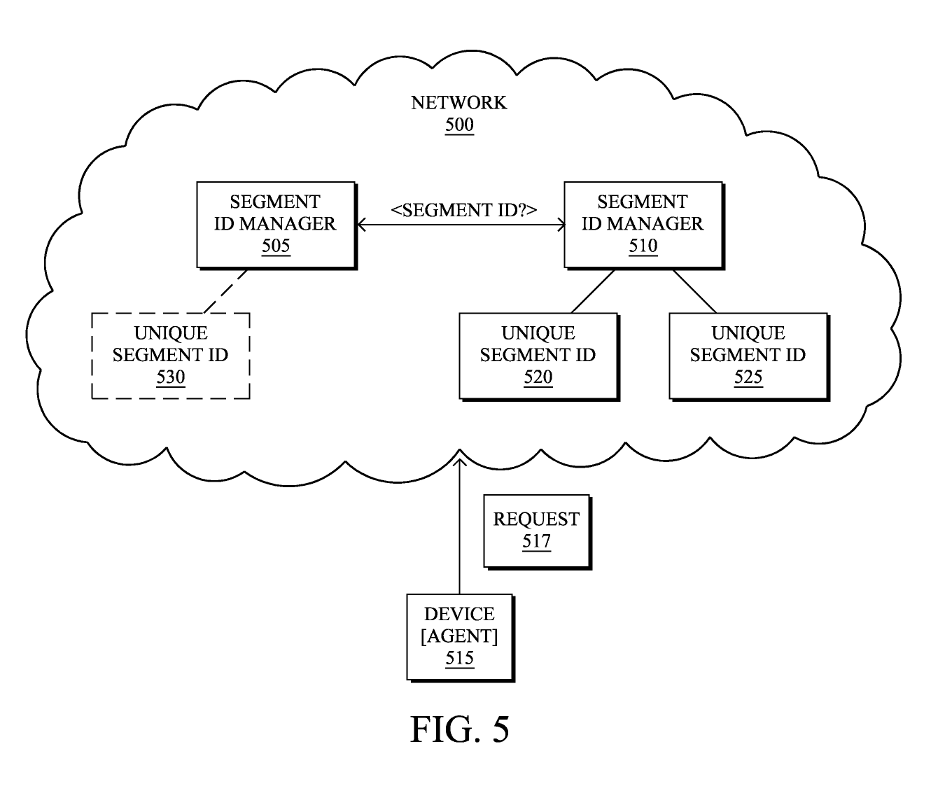

Additionally, FIG. 5 illustrates an example view of a network having multiple segment ID managers, e.g., for redundancy, distributed processing, or other purposes. In particular, as shown in FIG. 5, a network 500 according to one or more embodiments herein may have a first segment ID manager 505 and a second segment ID manager 510. Segment ID manager 510 further corresponds to network segment 520 and network segment 525 (each having unique segment IDs). In addition, network segment 520 and network segment 525 have devices (not shown) that are configured to communicate according to the unique network segment ID, similar to FIG. 3.

As illustrated, a device (or agent) 515 may send a request 517 for a unique segment ID for a network segment, e.g., to segment ID manager 505. As illustrated, segment ID manager 505 and segment ID manager 510 coordinate efforts to determine if the unique segment ID requested by device (agent) 515 exists, or needs to be instantiated. In particular, as the request is received at one segment ID manager (e.g., segment ID manager 505), the receiving manager may query the additional segment ID manager(s)—here segment ID manager 510, to determine if the unique segment ID has been previously generated. Alternatively, the request may be received by both segment ID managers at the same time.

For example, assuming request 517 is received by segment ID manager 505 first, segment manager 505 communicates the unique segment ID to segment ID manager 510 to determine if the unique segment ID was previously generated for the unique tenant ID and the protocol contained in the request-context of the request (e.g., for either network segment 520 or 525). In some embodiments, the request-context can further include a sub-tenant ID, in which case, the segment ID manager will determine if the unique segment ID was previously generated for the sub-tenant ID. If the unique segment ID was previously generated for the request-context, the segment manager 505 transmits a response indicating the unique segment ID for the network segment to the device (agent) 515. If the unique segment ID was not previously generated for the request-context (either by segment ID manager 505 or segment ID manager 510), the unique segment ID is instantiated (e.g., to-be-instantiated unique segment ID 530). After the unique segment ID is instantiated, the segment ID manager 505 transmits the response indicating the instantiated unique segment ID for a corresponding network segment to device agent 515. Notably, segment ID manager 505 and segment ID manager 510 can be physically remote, e.g., located in different data centers, though still able to communicate on a same network (e.g., network 500).

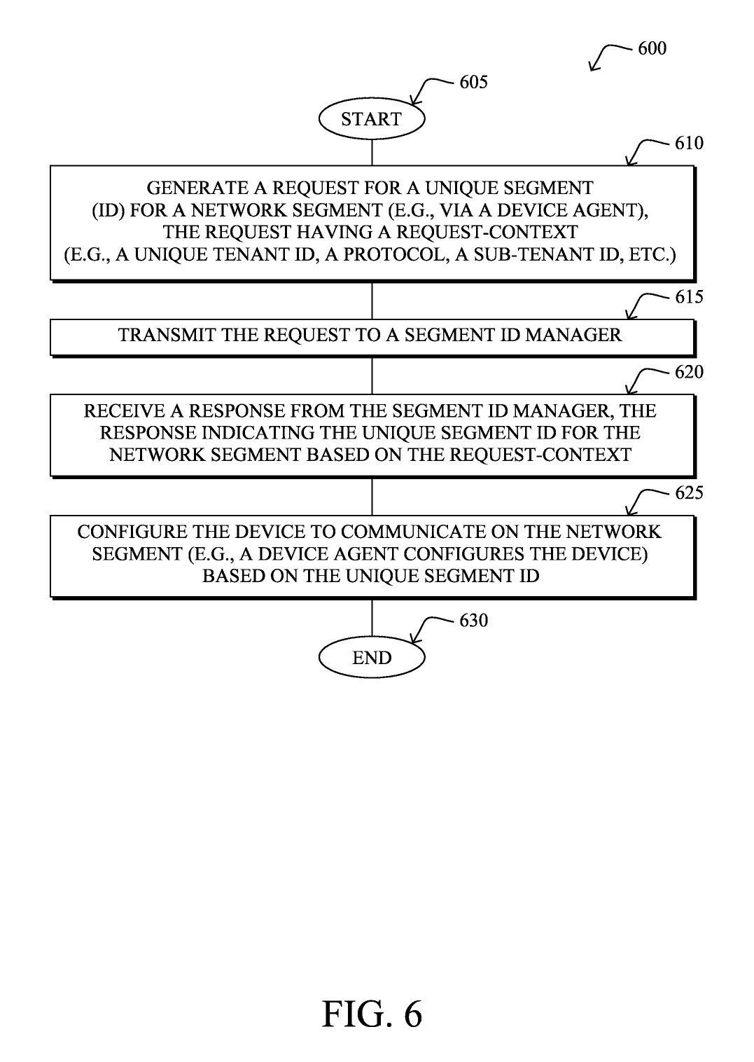

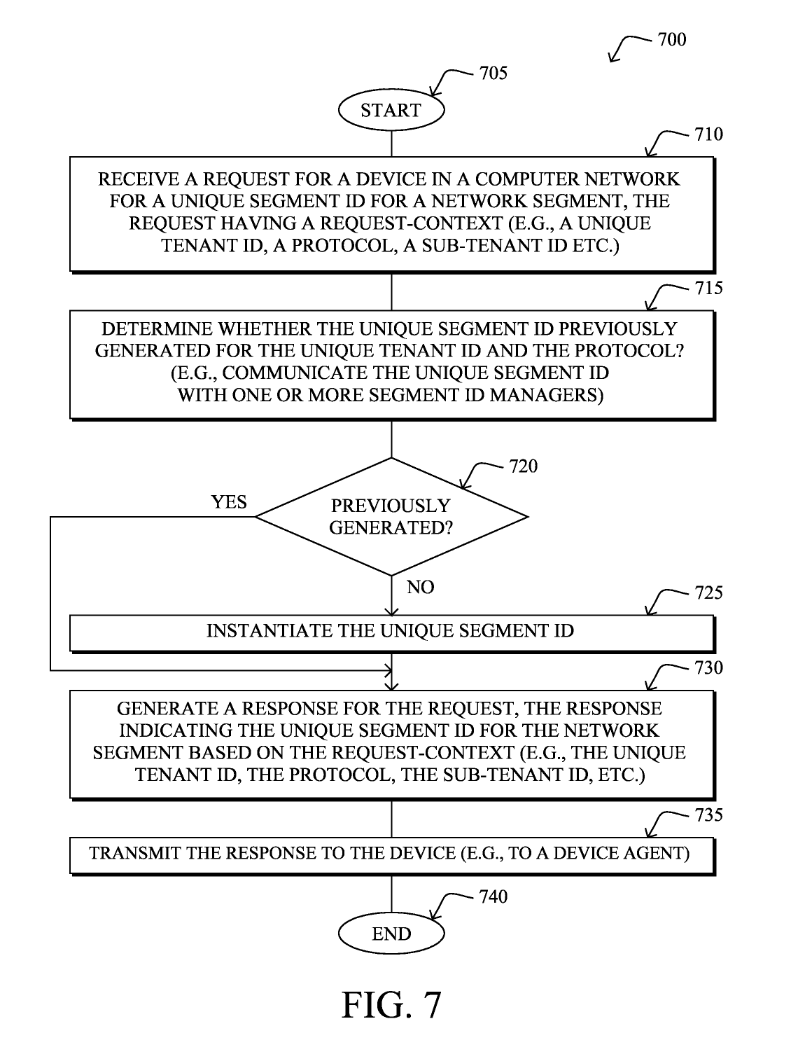

FIG. 6 illustrates an example simplified procedure, i.e., procedure 600, for provisioning segment identifiers based on tenant IDs in accordance with one or more embodiments described herein, particularly from the perspective of the configured device. Procedure 600 may start at step 605, and continues to step 610, where, as described in greater detail above, the device or device agent generates a request for a unique segment identifier (ID) for a network segment. The request includes a request-context comprising, for example, a unique tenant ID, a communication protocol, and a sub-tenant ID. In step 615 the device (agent) transmits the request to a segment ID manager. Typically, as discussed above, a segment ID manager will receive the request and transmit a response (e.g., according to procedure 700 of FIG. 7, below). In step 620, the device (agent) receives the response from the segment ID manager. The response indicates the unique segment ID for the network segment based on the request-context. In step 625, the device is configured (e.g., by the device agent) to communicate on the network segment according to the unique segment ID. The procedure 600 may subsequently end in step 625, or, may restart at step 605.

FIG. 7 illustrates another example simplified procedure, i.e., procedure 700, for provisioning segment identifiers based on tenant IDs in accordance with one or more embodiments described herein, particularly from the perspective of a segment ID manager. Procedure 700 may start at step 705, and continues to step 710, where, as described in greater detail above, the segment ID manager receives a request for a device in a computer network for a unique segment ID for a network segment, e.g., from the device itself or a device agent acting on behalf of the device. As described above, the request has a request-context that can include a unique tenant ID, a network communication protocol, a sub-tenant ID, etc. In step 715, the segment ID manager determines if the unique segment ID is previously generated for the unique tenant ID and the protocol (including the unique sub-tenant ID). The segment ID manager can communicate with other segment ID managers to make this determination. Step 720 represents the resultant determination from step 715. For example, a YES decision represents that the unique segment ID exists, and results in procedure 700 progressing to step 730. A NO decision represents non-existence of the unique segment ID, and results in procedure 700 progressing to step 725. In step 725, the segment ID manager instantiates a new unique segment ID for a network segment. If the unique segment ID exists (e.g., the YES decision from step 720), or once a new unique segment ID is instantiated (in step 725), the segment ID manager, in step 730, generates a response for the request. The response indicates the unique segment ID for the network segment based on the request-context. In step 735, the segment ID manager transmits the response to the device, or the device agent. Procedure 700 may subsequently end in step 740, or, may restart at step 705.

It should be noted that while certain steps within procedures 600-700 may be optional as described above, the steps shown in FIGS. 6-7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 600-700 are described separately, certain steps from each procedure may be incorporated into each other procedure, and the procedures are not meant to be mutually exclusive.

The techniques described herein, therefore, provide for infrastructure policies that assign a unique segment ID for a corresponding network segment according to a unique tenant ID. In particular, the techniques described herein provide for a unique context per tenant, which is used in generating and assigning unique segment IDs. This guarantees that unique segment IDs are different for different tenants, thereby providing efficient device isolation on particular network segments. Moreover, the techniques described herein, envision multiple segment ID managers that can assign tenant IDs in tandem.

By generating requests that contain the organizational context and the specifics of L2 and L3 segment IDs that are being requested, the same requests would be sent by multiple devices that need corresponding/complementary identifiers, and the segment ID manager(s) use the associated context to provide consistent IDs, accordingly. Essentially, this provides names to the networks, which as noted above, can be ported across data centers such that they provide the same network, wherein only the IDs change. This keeps context of the network such that it maintains connectivity to an external world. For instance, in one specific example, where a tenant has purchased a virtual data center, and segment IDs have been given out to the devices that have been provisioned for the virtual data center, a shutdown of this data center (without the distributed redundancy as mentioned above) would only impact the tenant for as long as it takes for the context to be reused elsewhere to recreate the data center.

While there have been shown and described illustrative embodiments that provide for configuration of devices to communicate on a particular network segment, and segment ID managers that assign unique segment IDs for corresponding network segments, it is to be understood that various other adaptations and modifications may be made within the spirit and scope of the embodiments herein. For example, the embodiments in their broader sense are not limited to particular networks or particular communication layers of the OSI model, but may, in fact, be used with any communication protocols of the various layers and for any type of device configuration. Moreover, while certain protocols are discussed, such as virtual routing and forwarding, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
generating a request for a particular device in a computer network for a unique segment identifier (ID) for a network segment comprising one or more devices sharing a unique tenant ID, the request having a request-context that includes at least the unique tenant ID and a protocol of the network segment;
transmitting the request to a segment ID manager;
receiving a response from the segment ID manager, the response indicating the unique segment ID for the network segment based on the request-context; and
configuring the particular device to communicate on the network segment with the one or more devices based on the unique segment ID of the response.

2. The method of claim 1, wherein the request-context further includes a sub-tenant ID, and wherein the unique segment ID for the network segment is based on the unique tenant ID, the sub-tenant ID, and the protocol of the network segment.

3. The method of claim 1, wherein the protocol of the network segment is selected from at least one of: a virtual routing and forwarding (VRF) protocol; a virtual local area network (VLAN) tagging protocol; a stacked VLAN protocol; a border gateway protocol (BGP); an interior gateway protocol (IGP); a multi-protocol label switching (MPLS) protocol; a wireless transmission protocol; and a tunneling protocol.

4. The method of claim 1, wherein a device agent generates and transmits the request on behalf of the particular device, and the device agent is adapted to configure the particular device to communicate on the network segment based on the unique segment ID.

5. The method of claim 1, wherein the unique segment ID was previously generated by the segment ID manager for a different device of the one or more devices having the shared unique tenant ID, and wherein the device and the different device are configured to communicate with each other on the network segment based on the unique segment ID according to the protocol of the network segment.

6. A method, comprising:
receiving, at a segment identifier (ID) manager, a request for a particular device in a computer network for a unique segment ID for a network segment comprising one or more devices sharing a unique tenant ID, the request having a request-context that includes at least the unique tenant ID and a protocol of the network segment;
determining if the unique segment ID was previously generated for the unique tenant ID and the protocol of the network segment;
instantiating the unique segment ID for the unique tenant ID and the protocol if the unique segment ID was not previously generated for the unique tenant ID and the protocol of the network segment;
generating a response for the request, the response indicating the unique segment ID for the network segment based on the request-context; and
transmitting the response to the particular device.

7. The method of claim 6, wherein the segment ID manager is one of a plurality of segment ID managers, the method further comprising:
communicating one or more unique segment IDs between the plurality of segment ID mangers; and
wherein determining if the unique segment ID was previously generated for the unique tenant ID and the protocol of the request-context comprises determining if the unique segment ID was previously generated for the unique tenant ID and the protocol by at least one of the plurality segment ID managers.

8. The method of claim 6, wherein the request-context further includes a sub-tenant ID, and wherein the unique segment ID for the network segment is based on the unique tenant ID, the sub-tenant ID, and the protocol of the network segment.

9. The method of claim 6, wherein the request is received from a device agent acting on behalf of the particular device, and wherein transmitting comprises transmitting the response to the device agent.

10. An apparatus, comprising:
one or more network interfaces adapted to communicate in a computer network;
a processor coupled to the network interfaces and adapted to execute one or more processes; and
a memory configured to store a process executable by the processor, the process when executed operable to:
generate a request for a particular device in the computer network for a unique segment identifier (ID) for a network segment comprising one or more devices sharing a unique tenant ID, the request having a request-context that includes at least the unique tenant ID and a protocol of the network segment;
transmit the request to a segment ID manager;
receive a response from the segment ID manager, the response indicating the unique segment ID for the network segment based on the request-context; and
configure the particular device to communicate on the network segment with the one or more devices based on the unique segment ID of the response.

11. The apparatus of claim 10, wherein the request-context further includes a sub-tenant ID, and wherein the unique segment ID for the network segment is based on the unique tenant ID, the sub-tenant ID, and the protocol of the network segment.

12. The apparatus of claim 10, wherein the particular device is the apparatus.

13. The apparatus of claim 10, wherein the unique segment ID was previously generated by the segment ID manager for the unique tenant ID of a different device of the one or more devices, the unique tenant ID of the device and the unique tenant ID of the different device being shared, and wherein the process, when executed, is further operable to:
communicate with the different device on the network segment based on the unique segment ID according to the protocol of the network segment.

14. An apparatus, comprising:
one or more network interfaces adapted to communicate in a computer network;
a processor coupled to the network interfaces and adapted to execute one or more processes; and
a memory configured to store a process executable by the processor, the process when executed operable to:
receive a request for a particular device in the computer network for a unique segment identifier (ID) for a network segment comprising one or more devices sharing a unique tenant ID, the request having a request-context that includes at least the unique tenant ID and a protocol of the network segment;
determine if the unique segment ID was previously generated for the unique tenant ID and the protocol of the network segment;
instantiate the unique segment ID for the unique tenant ID and the protocol if the unique segment ID was not previously generated for the unique tenant ID and the protocol of the network segment;
generate a response for the request, the response indicating the unique segment ID for the network segment based on the request-context; and
transmit the response to the particular device.

15. The apparatus of claim 14, wherein the apparatus is one of a plurality of segment ID managers, wherein the process, when executed, is further operable to:
communicate each unique segment ID between the plurality of segment ID managers, and
determine if the unique segment ID was previously generated for the unique tenant ID and the protocol of the request-context by determining if the unique segment ID was previously generated for the unique tenant ID and the protocol by at least one other segment ID manager.

16. The apparatus of claim 14, wherein the request-context further includes a sub-tenant ID, and wherein the unique segment ID for the network segment is based on the unique tenant ID, the sub-tenant ID, and the protocol of the network segment.

17. The apparatus of claim 14, wherein the request is received from a device agent acting on behalf of the particular device, and wherein the process, when executed to transmit the response to the particular device, is further operable to:
transmit the response to the device agent.

18. A system, comprising:
a plurality of devices, each configured to generate a request for a unique segment identifier (ID) for a network segment, the request having a request-context that includes at least a unique tenant ID for the plurality of devices and a protocol of the corresponding network segment;
a segment ID manager configured to receive the requests, determine if the unique segment ID has already been generated for the unique tenant ID and the protocol of the network segment, instantiate the unique segment ID for the unique tenant ID and the identified protocol if the unique segment ID was not previously generated for the unique tenant ID and the protocol of the network segment, and transmit a response for each of the received requests that indicates the unique segment ID for the corresponding network segment; and
wherein the devices are configured to receive the response for the respective request and are configured to communicate on the corresponding network segment based on the unique segment ID of the response.

19. The system of claim 18, further comprising:
one or more device agents for one or more corresponding devices, wherein each device agent is adapted to generate the request and receive the response on behalf of the corresponding device, and configured to communicate on the corresponding network segment based on the unique segment ID of the response.

20. The system of claim 18, wherein the protocol of the network segment is selected from at least one of: a virtual routing and forwarding (VRF) protocol; a virtual local area network (VLAN) tagging protocol; a stacked VLAN protocol; a border gateway protocol (BGP); an interior gateway protocol (IGP); a multi-protocol label switching (MPLS) protocol; a wireless transmission protocol; or a tunneling protocol.
